(19) United States
(12) Patent Application Publication
(10) Pub. No.: US 2003/0155279 A1
(43) Pub. Date: Aug. 21, 2003

(54) Screening method for size sorting of feathers, down, wood needles, or the like maintained in suspension in a fluid

(76) Inventor: Christian Monjarret, La Poterie (FR)

Correspondence Address: Arnold S Weintraub, Plunkett & Cooney, Suite 3000, 38505 Woodward Avenue, Bloomfield Hills, MI, 48304, US

(21) Appl. No.: 10/204,616

(22) PCT Filed: Feb. 16, 2001
(86) PCT No.: PCT/FR01/00468

(30) Foreign Application Priority Data
Feb. 21, 2000 (FR) 00/02106

(51) Int. Cl. B07B 1/00; B03B 1/00

(52) U.S. Cl. 209/132

(57) ABSTRACT

The invention concerns a screening method and machine for size sorting in a fluid (9), into two categories, of materials with different volumes and density close to that of the fluid used after total immersion in said fluid. Mechanical stirring (6) means upstream of the sieves, optionally combined with the use of surfactants in an aqueous medium, maintain said materials to be size-sorted suspended in said fluid. The fluid circulates from upstream to downstream of the sieves. Only the materials below a certain size, volume or weight, maintained suspended in the fluid, pass through the size-sorting sieves (15). The sieves are immersed in the fluid and do not slow down the liquid flow passing through them. To obtain further size-sorted categories, it is possible to organise the inventive process sequentially. The invention is useful in poultry processing plants, processing feathers and down for padding purposes, purifying foreign matter in pasty mixtures and the like.

The invention provides a solution for sizing materials of variable sizes and densities close to that of the fluid in which they are fully immersed and dividing them into two categories.

History:

Separation by means of centrifugation of materials immersed in a fluid is a common operation, but it imposes two constraints. First of all, the materials are required to have a density that is significantly different from that of the fluid. Secondly, if the mixture is a random mixture of materials of varying forms and volumes, the materials are difficult to separate by mere centrifugation as a self screening effect is created by the amalgamation of materials from the two groups to each other, as a result of the differing volume and bonding ability of the materials.

Fluid is never used to separate materials with a density close to that of the fluid after total immersion. For instance, while sizing bird feathers for bedding, the method used is that of sizing dry feathers by air suction columns (called sorting machines). The principle consists in agitating feathers of varying sizes at the base of an air suction column. The lower the suctioning power, the finer and lighter the materials suctioned into the ascending column. However, as the feathers are moist or wet as they come out of the abattoir, the material has to be dried before such dry sizing by air columns is possible. Also, preliminary washing may be required in addition to drying when the sized material is fatty or soiled. Excess fat makes drying difficult and drying fixes the fat onto the feathers. Excess soiling of the feathers changes their actual weight, interfering with sizing by the column suction method. Lastly, soiled feathers can also have a foul odour and foul the machinery used for processing prior to washing.

This is where the invention is useful. Given that with any bird, say a duck, 35 to 45% the feathers by weight are rejected from the bedding application at the end of the complete feather treatment process (washing, staving, dusting, storage, transport etc.), it would be more efficient to separate the feathers suitable for bedding and those sent on to rendering facilities at the start of the process. When used to size feathers, the prototype based on this invention provides dramatic results. The invention can be used to obtain several sizing results by changing the screen mesh. In the feather example, feathers larger than approximately 5 centimetres can be separated from other smaller feathers with differing shapes. These smaller sizes are the quality component of the original material, with the greatest value in the feather market. As a result, it is preferable to size the material in a fluid and only retain the finest elements of the original material for processing. Also, if sizing in a fluid is performed in the abattoir with the very water that is used to move the feathers along in the abattoir, only the selected feathers will be transported to the feather processing factory and the larger ones can be sent directly to the renderers. The system offers a number of other advantages that can be appreciated by the industry.

The invention proposes a process and a preferred machine in order to size materials in a fluid. The volume of the material is variable and its density after full immersion is close to that of the fluid or even less. That is so, for example, of wood needles of a few centimetres or miscellaneous bird feathers used to fill bedding. The lists of materials that can be sized are not exhaustive.

The method of sizing bird feathers, wood needles or similar materials of the present invention by means of fluid which densities after full immersion are close to that of said fluid or even less characterized by the fact it consists on one hand to realize in a sealed enclosure upstream of said fluid to keep suspended said materials in said fluid and to bring them toward screening means, a circular mixing of said fluid to keep suspended said materials in said fluid and to bring them toward means of screening and on the other and by the fact the fluid is kept flowing continuously through means of screening to run the materials to select.

Fluid is kept flowing continuously through a screen, carrying with it the components that are finer than the screen mesh.

The staggered mixing of the fluid and sized materials means that the materials do not form clumps or stick to each other at the entrance of the screen when the fluid flows through the screen.

Such mixing can be achieved by means of a shaft and blades to create a slight centrifuge effect in a cylinder that may be vertical or otherwise. That centrifuge effect is useful if the relative densities of the sized materials are different and when those that are expected to pass through the screens are denser than the others. It facilitates screening by bringing the materials closer to screens located at the edges, on the walls of the mixing enclosure.

As they are mixed, the materials may be subjected to chemical treatment in an aqueous solution by adding surfactants or other chemicals during the sizing process, with the fluid flowing in a closed circuit. Surfactants may be used to improve the wettability of the material, dye or disinfect it or for other purposes. A surfactant or additive may also be used to modify the relative densities of the fluid and the sized material in order to improve the tendency of the material to remain suspended in the fluid after it is immersed in the fluid.

In one embodiment of the present invention the machine comprises a sealed enclosure surrounding a mixing enclosure in a cylindrical or polygonal shape which is supplied with fluid, said mixing enclosure having screening means intended to run only the materials to select under the effect of the fluid which is kept flowing continuously from said mixing enclosure toward sealed enclosure which has a drain of said fluid and materials selected.

The machine may comprise a succession of two or more mixing enclosures, each mixing enclosure with its own specific characteristics.

In other embodiment of the present invention the machine comprises a sealed enclosure having screening means delimiting the inner space of said sealed enclosure in a mixing space which is supplied with fluid, having mixing means and a space to evacuate the fluid and the materials run through said screening means and by the fact it comprises a drain connected to the evacuating space.

The screening means may be made up of a series of tube with a length and a diameter, where the outlet orifices have a stop, forming a bend open on one side, with a length greater than diameter, separated by a certain distance from the outlet orifice, the ratio between length of a tube and the distance between the stop and the outlet orifice being evaluated on the basis of the characteristics of the sized materials and the diameter of said tube.

The tubes are juxtaposed in linear series with a bent stop per series of tubes, the linear series are positioned perpendicularly to the direction of the flow of the same fluid and material mixture on the basis of the result to wait and the shape of the screens.

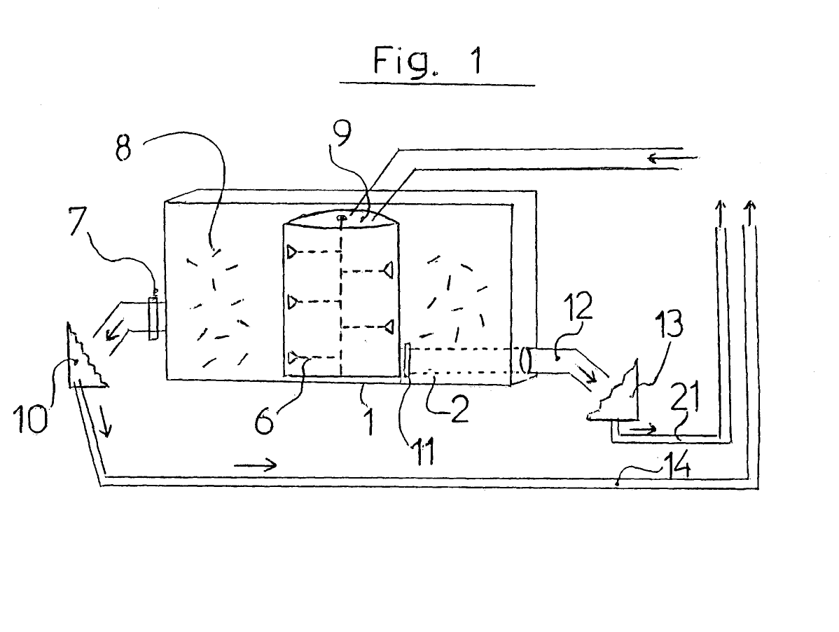

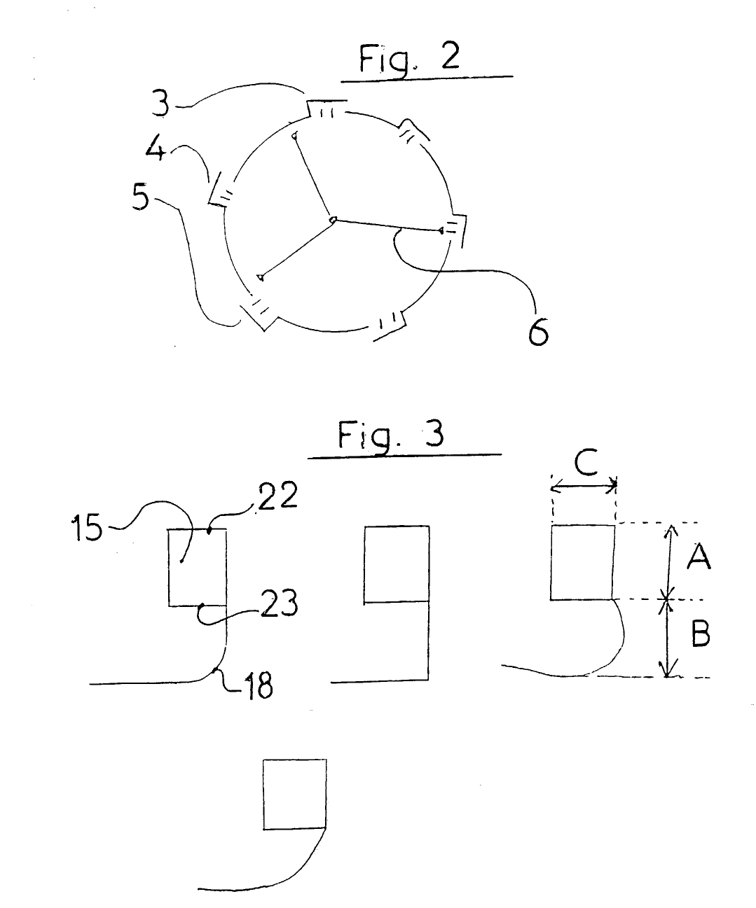

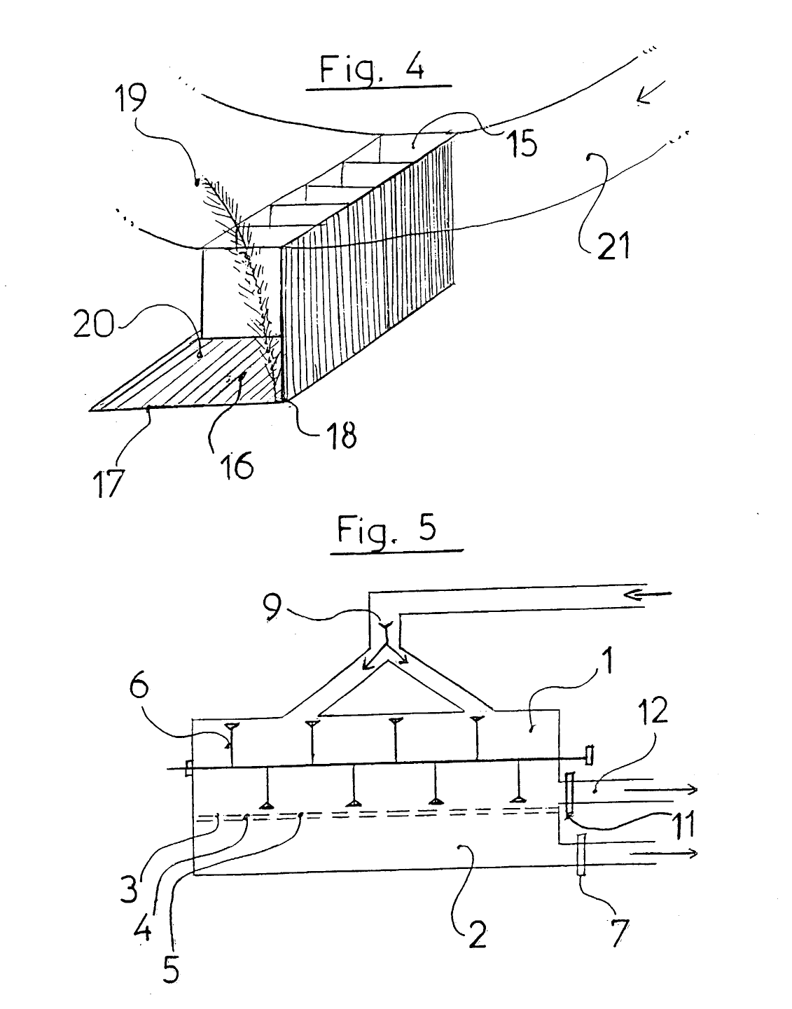

The sized material must be kept suspended in the fluid during the entire sizing process. To achieve that, the screen must not bottleneck the flow of fluid and materials as they pass through the screen. The screen is immersed between two areas of fluid with significantly identical pressures, where the pressure before the screen is slightly higher in order to create a flow from one area to the other. For example (FIGS. 1 and 2), this may be achieved by means of two enclosures, one inside the other, with screens (3, 4 and 5) fixed to the walls of the smaller of the two (1). The fluid flows into (9) the smaller enclosure and passes through the screens into the larger enclosure (2), which is sealed. That larger enclosure has a drain (7) with a flow rate equal to the inflow (9) into the smaller enclosure so that the level of fluid remains stable and significantly equal in the two communicating enclosures. As the fluid flows, the sized materials individually pass through the, screen or are held back, depending on the screen. At this point, the perfection of sizing is greater when the flow of fluid through the screens is slower. A second method for the application of the invention is to divide a single enclosure (FIG. 5) with the help of screens into two areas placed one above the other (1 and 2), with the fluid flowing by gravity from the upper area (1) to the lower area (2) through the screens (3). A drain (7) for the fluid from the lower area creates the flow, but that flow is regulated on the basis of the screen mesh and the sized material in order to prevent the formation of a bottleneck at the screen entries. A compromise must be found in order to obtain rapid sizing and efficiency. Among other things, that compromise depends on the number of orifices that make up the screen and the fineness of the sizing required.

The screen characteristics depend on the sized materials. The screen is made up of two main parts, one of which includes multiple tubes (15) juxtaposed in linear series. Those linear series of tubes are positioned on the walls of the mixing enclosure (1), perpendicular to the direction of the mixing in the enclosure (FIG. 4). The other is an outlet stop (23) for each series of tubes. For instance, the tubes (15) juxtaposed in lines or in a chequered configuration form the orifices (22 and 23) of the screens and their shape and size is adapted to the sized materials. The tubes (15) have an identical shape, more or less elongated (A) with a variable diameter (C). Each tube must preferably be straight in order to eliminate the risk of blocking materials with curved shapes or placed in the direction opposite the curve of the tube. The screen stop (17) forms a bend (18) close to 90 degrees, open on one side only (20) in order enable fluid and materials to flow through the screen. The opening of the stop (20) is turned in the direction of the mixing of the fluid in the screening enclosure. The stop is positioned at the outlet (23) of the screen tubes, but at a distance (B) that is sufficient to enable the flow of fluid and selected materials. The total length of the tubes and the space between the ends of the tubes and the stop (A+B) is such that the longer elements cannot pass beyond that screen. For instance, if material (FIG. 4) such as a feather (19) engaged in a tube (15), in contact with the stop (17) is not long enough to sufficiently exceed the inlet orifice (22) of the tube, a compromise between sizes A, B, C and D of the screen must enable the material to flow past the screen with the help of the friction in the screen parts in the fluid alone or the fluid charged with materials. The aim is to not obstruct the orifices of the screen, in order not to create a bottleneck for the flow of fluid and any material flowing through.

By using a closed circuit for the fluid, the quantity of fluid to be used during the sizing process can be saved. To do so, the selected materials flow through the screen into the enclosing tank (2) that is around the first one (FIG. 1) and then through the draining valve (7) of the second enclosure. They are then separated from the fluid by means of a separating system. After that separating system, the fluid separated from the selected materials is sent back to a pumping system, for instance, to the top of the sizing process, into the enclosure with the screen. For their part, the selected materials are grouped and directed to a staging or processing area away from the invention.

Lastly, those materials that are held back by the screens during the sizing process are retained in the screening enclosure. At the end of the time set aside for sizing, the rejected materials are removed from the enclosure by a system adapted to the configuration of the enclosures (11 in FIGS. 1 and 4) before the next sizing cycle with fresh materials. The fluid charged with rejected materials is also separated from the said materials by a separating system. The fluid is sent back to the top of the sizing process in the screening enclosure. The rejected materials are moved away from the invented machine at this point of the sizing process.

FIG. 1 shows a lateral perspective of an example of two enclosures, one inside the other, one of which has a mixing system with blades and a closed fluid circuit.

FIG. 2 is a top view of the tank with a screen and a central shaft with blades for mixing the immersed materials.

FIG. 3 offers a front view of several possible modes of screens with rectangular orifices and the stop with a bend close to 90 degrees.

FIG. 4 is another view of the same screen mode as in FIG. 3, only with a raised lateral perspective. The screen shown is attached to the wall (21) of the cylinder. As an example, a feather is positioned in one of the orifices of the screen but is stopped by the stop plate because of its length and rigidity.

FIG. 5 supplements FIG. 1 and shows another possible configuration of the enclosures. These are placed one above the other and separated by the screens. The numbers are the same as in FIG. 1 for the equivalent functions.

A preferred method for applying the invention is:

The principle is based on the flow of fluid from an initial area to a secondary area via a screen, with the help of a continuous supply of fluid before the system, in proportion with the flow of fluid leaving the secondary area through a draining valve, thanks to the effect of communicating vessels. The fluid carries some of the materials from the initial area to the drain of the secondary area.

The prototype developed proposes a preferred mode of embodiment of the invention, applied to unprocessed wet duck feathers.

Use a vertical cylindrical tank (1) such as a standard 200-litre drum, positioned in a tank (2) of any shape, but high enough to ensure that the cylinder (1) can be immersed up to approximately three-quarters of its height.

The cylinder (1) is fitted with screens (3, 4 and 5) distributed over the edge, in vertical rows of openings that are sufficient in number to enable a flow of fluid that allows for efficient sizing. The columns of orifices are as high as the cylinder itself, with the exception of an offset at the base of the cylinder to allow for heavy particles such as metal pieces, pebbles and bird viscera if the feathers come directly from the abattoir etc. that are thus deposited at the base of the cylinder. In that way, the unwanted heavy particles, which can sometimes be small in size, do not pass through the screen, damage the screen or clog it. A motorized shaft with blades (6) goes through the cylinder. The blades graze the screens.

The screens are a series of small tubes (15), square or otherwise, with sides or diameters of approximately 2-5 centimetres (C) and a length of approximately 3 -5 centimetres (A). A plate (17) acting as a stop is fixed on the side of the outlet (23) of the tube so that materials that are too long or too rigid that may be engaged in the small tubes are stopped by the plate and go back into the cylindrical tank as a result of the mixing action in the cylinder. The materials or the turning of the fluid move the materials that are temporarily placed in the small tubes of the screen and clear the orifices (22) once again to continue the sizing process. The bent (18) stop plate (17) is placed at a distance of approximately 2-3 centimetres (16) from the outer end of the tubes (23) and is open (20) on the side opposite the fluid mixing direction in the cylinder. In that way, an element (e.g. a feather, see FIG. 4) that is much longer than A+B stopped by the stop plate (17) tends to be placed obliquely in relation to the mixing direction (19). The base of the element must be stopped till it is cleared by the mixing action, without any risk of its being carried by the continuous flow of fluid converging towards the outside of the cylinder through the screen. On the other hand, an element (e.g. a feather) that is slightly longer than A+B or shorter than A+B that is stopped by the plate is unlikely to move back towards the enclosure before the screens as a result of its small catching surface before the tube, reducing its tendency to be caught by the friction of materials and the fluid before the screens. At this point, the material must move down from the screen, thanks to the opening of the screen (20) which is sufficiently large to enable the element in this example to be placed obliquely in the screen and therefore pass the bend in the stop despite its rigidity and length.

The fluid charged with materials selected (8) by means of the screen is delivered to a tank acting as an enclosure (2), which is of any shape but is watertight and surrounds the cylinder (1), because in this example of an embodiment of the invention, the screens are distributed over its entire periphery. The fluid level in the enclosure that surrounds the cylinder is necessarily close to that of the cylinder.

The flow of fluid is provided by an inflow (9) into the cylinder (1) and a variable-rate drain (7) from the enclosing tank (2). In that way, the flow of fluid is almost identical at all the stages of the sizing process, at the three following locations: inflow through the top of the first cylinder, flow through the orifices of the screen and flow out of the drain of the enclosing tank.

For the example feathers, a small-sized prototype was designed with characteristics that do not limit the possibilities of designing a sizing machine in accordance with the invention. The stages of the process are as follows:

Fill three-quarters of the volume of the two tanks communicating via a screen with fluid that is not charged with materials. This is felt to be the reasonable level for correct operation without overflowing. The draining valve of the enclosing container is kept closed while the tanks are being filled.

Now introduce the material to be sized in the cylinder (1) with a shaft and five blades rotating at about 90 rpm. If the feathers are dry, they will be immersed completely by mixing in the cylinder. Such immersion is required for sizing with fluid. At this point of the process, a chemical may be added in order to treat the material. However, the chemical must be non foaming. For example, a non foaming degreasing agent could be used to wash the feathers during the sizing process. A surfactant added to the fluid, say water, could also improve the wettability of the feathers. The quantity of unprocessed feathers to be added to the cylinder (1) in equivalent dry weight is approximately 3 to 7 kilograms for the cylinder of the prototype, 50 centimetres in diameter and 80 centimetres high. The greater the proportion of material that is expected to be held back by the screens, the smaller the quantity of material to be introduced at the start of the sizing cycle. That is because sizing will be less effective if during the entire process, the mixing cylinder is saturated with material that is to remain in the cylinder. Of course, mixing improves sizing by unclogging the screen's at regular intervals.

The sizing process can now be started by opening the inflow valve (9) at the top of the cylinder and the draining valve (7) located at the outlet of the enclosing tank, simultaneously and at the same rate. The sizing time for four kilograms is approximately three minutes with the prototype. That speed can be increased by using larger screens, larger tanks and cylinders or by increasing the flow rate etc.

In order to save the quantity of fluid required for the sizing process, the invention provides for a closed circuit (14) to recover the fluid after the draining valve (7), after it is cleaned of the selected feathers by means of a separating system (10). The selected feathers, which have gone through the screen, are removed from the system by means such as a conveyor.

At the end of the time set aside for sizing, i.e. three minutes in the example, the feathers held back in the mixing cylinder (1) are ejected with some system or the other, providing there is no communication with the tank (2) in which a few selected materials might still be suspended in the water. The circulation of fluid is maintained but the circuit is temporarily modified as follows—at the end of the sizing process, the draining valve (7) of the tank (2) closes and at the same time, the valve (ii) located at the base of the cylinder (1) opens to release the fluid with feathers caught in the cylinder into a pipe (12) passing through the tank (2) and opening out into a separating system (13) in order clean the fluid of the large feathers. The water is reused in a closed circuit (21) in the invention. As the material caught in the cylinder is eliminated, the inflow of water at the top of the cylinder must be sufficient for two reasons—first of all, it must move the large feathers to the pipe (12), the clumping effect being reduced by the mixing in the cylinder, and secondly it must avoid the reversal of the flow from the tank to the cylinder (1) as a result of the communicating vessel effect, if the level of fluid in the cylinder drops because the draining rate is greater than the inflow rate, thereby making selected materials suspended in the enclosing tank cross back through the screen. Such a reversal of flow would cancel some of the benefit of the sizing system, which is the object of the invention. The time taken to drain out the feathers caught in the cylinder can be reduced to a few seconds with an efficient system for draining out the fluid and materials. The cylinder valve (11) closes and that of the enclosing tank (7) opens again in order to resume the initial flow circuit for sizing from the mixing tank to the enclosing tank via the screen. Materials can now be introduced once again and the process follows the previously described stages.

The sizing process described may be modified on the basis of the composition of the materials to be sized. For instance, if the materials mainly include elements that can pass through the screen, the materials caught before the screen will have not have to be drained at the end of the each cycle, as their quantity will be small. In that case, the sizing process is as follows—regular and continuous inflow of materials into the mixing tank before the screens, followed by the sizing process as described in the invention over a sufficiently long duration, followed by the draining proper of the materials caught before the screens, in accordance with the process described in the invention. The process is used to significantly heighten sizing productivity when most of the materials are expected to pass through the screen.

The hourly speed can reach several hundreds of kilograms of unprocessed feathers in equivalent dry weight, depending on the size of the machine. The invention can be adapted fully and easily in terms of the size of the system using juxtaposed modules. For instance, an enclosing tank may contain several cylinders with mixing systems and screens. The size of the mixing cylinder may also be large.

Besides, in the example, the invention is used to eliminate most the feathers that are not usable for bedding applications, i.e. up to 40% of the feathers by weight introduced in the machine. The machine can size feathers according to the desired length. In that case, the treatment of bedding feathers is only applied to materials sized by the invention.

Also, wet feathers from abattoirs are often charged with all sorts of waste, such as feet and heads, viscera or even entire birds from the slaughter chain. These unwanted materials make it difficult to wash the feathers in one operation as a result of the odours created by stoving after washing. The invention offers a suitable solution by making it possible to hold back the foreign elements within the mixing tank as a result of the screen and the lower part of the tank, which retains the heavier elements.

Tests with the prototype have made it possible to separate feathers of sizes below 4 centimetres from the others. The type of screen used had tubes with orifices of smaller sizes, and the distance between the end of the tubes and the stop was smaller, all other things being equal. That makes it possible to use the invention in successive stages in successive sizing enclosures with suitable screens in order to size unprocessed material into three or four different sizes-in the same flow. The first enclosure holds back the largest elements whilst the remainder flow to a second enclosure, which holds back the largest elements out of those and so on.

1) Method of sizing bird feathers, wood needles or similar materials by means of fluid which densities after full immersion are close to that of said fluid or even less characterized by the fact it consists on one hand to realize in a sealed enclosure (2) upstream of said fluid to keep suspended said materials in said fluid and to bring them toward screening means (3,4,5), a circular mixing of said fluid to keep suspended said materials (8) in said fluid and to bring them toward means of screening (3,4,5) and on the other and by the fact the fluid is kept flowing continuously through means of screening to run the materials (8) to select.

2) Method in accordance with claim 1 characterized by the fact a surfactant is used in the closed fluid circuit during the mixing and sizing process of materials (8) to improve the wettability of materials (8).

3) Method in accordance to claim 1 or claim 2 characterized by the fact a surfactant or an additive is used in the closed fluid circuit during the mixing and sizing process of materials (8) to modify the density of the fluid or the sized material in order to heighten its tendency to remain suspended in the fluid after immersed.

4) Machine in accordance with any of the previous claim characterized by the fact it comprises a sealed enclosure (2) surrounding a mixing enclosure (1) in a cylindrical or polygonal shape which is supplied with fluid, said mixing enclosure (1) having screening means (3,4,5) intended to run only the materials to select under the effect of the fluid which is kept flowing continuously from said mixing enclosure (1) toward sealed enclosure (2) which has a drain (7) of said fluid and materials selected.

5) Machine in accordance with claim 4 characterized by the fact the mixing enclosure has a pipe to evacuate, by overflowing, materials (8) which are not selected.

6) Machine in accordance with claim 4 or claim 5 characterized by the fact it comprises a succession of two or more mixing enclosures (1), each mixing enclosure (1) with its own specific characteristics.

7) Machine in accordance with claims 1 to 3 characterized by the fact it comprises a sealed enclosure (2) having screening means (3,4,5) delimiting the inner space of said sealed enclosure (2) in a mixing space (1), which is supplied with fluid, having mixing means and a space to evacuate the fluid and the materials (8) run through said screening means (3,4,5) and by the fact it comprises a drain (7) connected to the evacuating space.

8) Machine in accordance with claim 7 characterized by the fact it comprises a pipe (12) to evacuate, by overflowing, materials (8) which are not selected.

9) Machine in accordance to claims 4 to 8 characterized by the fact the screening moans (3,4,5) are made up of a series of tube (15) with a length (A) and a diameter (C), where the outlet orifices (23) have a stop (17), forming a bend (18) open on one side (20), with a length (D) greater than diameter (C), separated by a certain distance (B) from the outlet orifice (23), the ratio between length (A) of a tube (15) and the distance (B) between the stop (17) and the outlet orifice (23) being evaluated on the basis of the characteristics of the sized materials and the diameter of said tube (15).

10) Machine in accordance to claim 4 to 9 characterized by the fact the tubes (15) which make up a screen are juxtaposed in linear series with a bent stop per series of tubes, the linear series are positioned perpendicularly to the direction of the flow of the same fluid and material mixture on the basis of the result to wait and the shape of the screens.
